(19) United States
(12) Patent Application Publication
(10) Pub. No.: US 2017/0013799 A1
(43) Pub. Date: Jan. 19, 2017

(54) TRAINING PADS FOR PETS

(71) Applicant: Jonathan Bolton, Los Angeles, CA (US)

(72) Inventor: Jonathan Bolton, Los Angeles, CA (US)

(73) Assignee: Metro Paws LLC, Los Angeles, CA (US)

(21) Appl. No.: 15/212,032

(22) Filed: Jul. 15, 2016

Related U.S. Application Data
(60) Provisional application No. 62/192,996, filed on Jul. 15, 2015.

(51) Int. Cl. A01K 1/015; B32B 27/06; B32B 7/12; A61L 9/014

(52) U.S. Cl. CPC A01K 1/0157; A01K 1/0152; A61L 9/014; B32B 27/06; B32B 7/12; A61L 2209/22; A61L 2209/13; B32B 2323/04

(57) ABSTRACT

The present disclosure generally relates to pets training pads and more specifically to dog training pads. In one embodiment of the present disclosure, the training pads comprise: multiple layers of absorbent made from superabsorbent polymer, a layer of polyethylene film and an attractant, wherein the attractant releases a special scent which attracts/reminds the pets to use the training pads. The training pads further comprise a fragrance that eliminates urine odor after the training pads have been used.

### CROSS-REFERENCE TO RELATED PATENT APPLICATIONS

Embodiments of the present invention relate to U.S. Provisional Application Ser. No. 62/192,996, filed Jul. 15, 2015, entitled “TRAINING PADS FOR PETS”, the contents of which are incorporated by reference herein in its entirety and which is a basis for a claim of priority.

### FIELD OF THE INVENTION

Embodiments of the present disclosure generally relate to training pads for pets and more specifically to training pads for dogs which have multiple layers of protection that provide enhanced fluid absorption.

### BACKGROUND

Pet training pads have been in use for many years. A pet training pad is basically an absorbent mat that can be placed on a floor so that pets can urinate and defecate on the pad. These pads usually are available in variety of sizes with an absorbent material on the front and a plastic backing. They are often used for the convenience of people who live in apartments or other locations, in which it may be difficult to let the pets go outside for relief. Many working people also use the pads to provide their pets a place for relief while they are gone.

While the training pads are convenient to pet owners, some pets are not attracted to conventional training pads because of their appearance and/or scent. In addition, most of the conventional training pads have poor water absorption and leave strong urine odor after being used.

Accordingly, there exists a need to provide training pads that attracts dogs. There also exists a need to provide training pads with enhanced fluid absorption. Lastly, there also exists a need to provide training pads that are capable of reducing or eliminating animal waste odor.

### SUMMARY OF THE DISCLOSURE

One objective of the present disclosure is to provide training pads for pets that attract pets and have enhanced fluid absorption.

Another objective of the present disclosure is to provide training pads for pets that reduce and/or eliminate urine and/or feces odor and provide fresh fragrance after being used.

In accordance with one aspect of at least one embodiment of the present disclosure, the training pads comprises: 1) a top layer made from superabsorbent polymer and includes a visual design; 2) a bottom layer made from a non-porous material; 3) at least two layers of absorbent made from superabsorbent polymer are placed between the top layer and the bottom layer; and 4) an attractant.

The foregoing and other objects, features and advantages of the present invention are more readily apparent from the detailed description of the preferred embodiments set forth below, taken in conjunction with the accompanying drawings.

### BRIEF DESCRIPTION OF THE DRAWINGS

FIG. 1 is a schematic drawing according to an exemplary embodiment of the present invention.

FIG. 2 is a schematic drawing according to an exemplary embodiment of the present invention.

FIG. 3 is a schematic drawing according to an exemplary embodiment of the present invention.

FIG. 4A is a schematic drawing according to an exemplary embodiment of the present invention.

FIG. 4B is a schematic drawing according to an exemplary embodiment of the present invention.

FIG. 4C is a schematic drawing according to an exemplary embodiment of the present invention.

### DETAILED DESCRIPTION OF PREFERRED EMBODIMENTS

The following description is not to be taken in a limiting sense, but is made merely for the purpose of illustrating the general principles of the invention, since the scope of the invention is best defined by the following claims. Various inventive features are described below that can each be used independently of one another or in combination with other features.

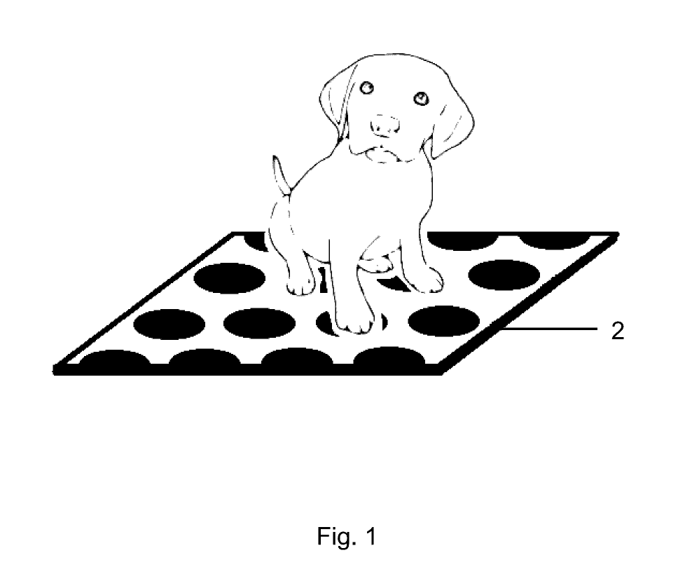

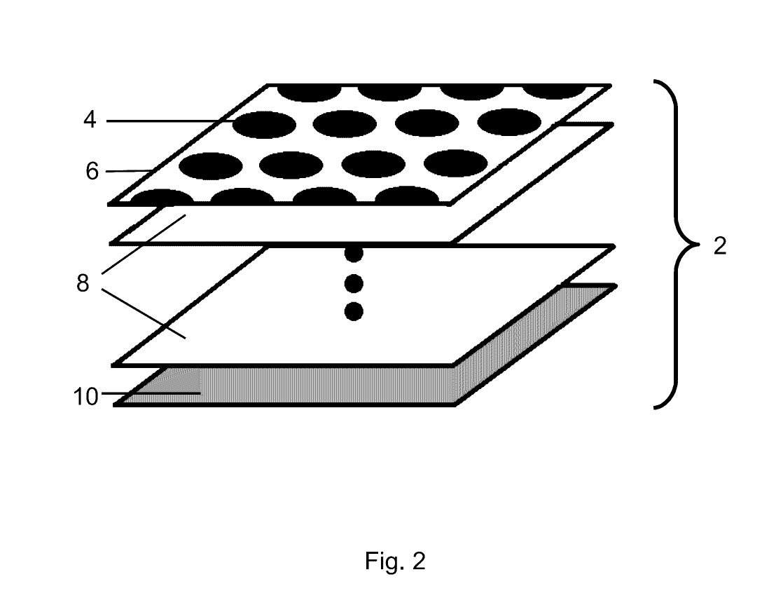

Broadly, embodiments of the present disclosure generally provide pets training pads. In accordance with one embodiment of the present disclosure, as shown by FIGS. 1 and 2, a training pad 2 comprise: a top layer 6 made from superabsorbent polymer (SAP) and includes a visual design 4; a bottom layer 10 made from a non-porous material; at least two layers of absorbent 8 made from superabsorbent polymer are placed between the top layer 6 and the bottom layer 10; and an attractant (not shown).

Superabsorbent polymer (SAP), sometimes being referred as slush powder, are polymers that can absorb and retain extremely large amounts of a liquid relative to their own mass. Water-absorbing polymers, which are classified as hydrogels when cross-linked, absorb aqueous solutions through hydrogen bonding with water molecules. A SAP's ability to absorb water is a factor of the ionic concentration of the aqueous solution. In deionized and distilled water, a SAP may absorb 300 times its weight (from 30 to 60 times its own volume) and can become up to 99.9% liquid, but when put into a 0.9% saline solution, the absorbency drops to maybe 50 times its weight. The presence of valence cations in the solution impedes the polymer's ability to bond with the water molecule.

The total absorbency and swelling capacity are controlled by the type and degree of cross-linkers used to make the gel. Low-density cross-linked SAPs generally have a higher absorbent capacity and swell to a larger degree. These types of SAPs also have a softer and stickier gel formation. High cross-link density polymers exhibit lower absorbent capacity and swell, but the gel strength is firmer and can maintain particle shape even under modest pressure.

Superabsorbent polymers can be made from the polymerization of acrylic acid blended with sodium hydroxide in the presence of an initiator to form a poly-acrylic acid sodium salt (sometimes referred to as sodium polyacrylate). Other materials can also be used to make a superabsorbent polymer, such as polyacrylamide copolymer, ethylene maleic anhydride copolymer, cross-linked carboxymethylcellulose, polyvinyl alcohol copolymers, cross-linked polyethylene oxide, and starch grafted copolymer of polyacrylonitrile to name a few.

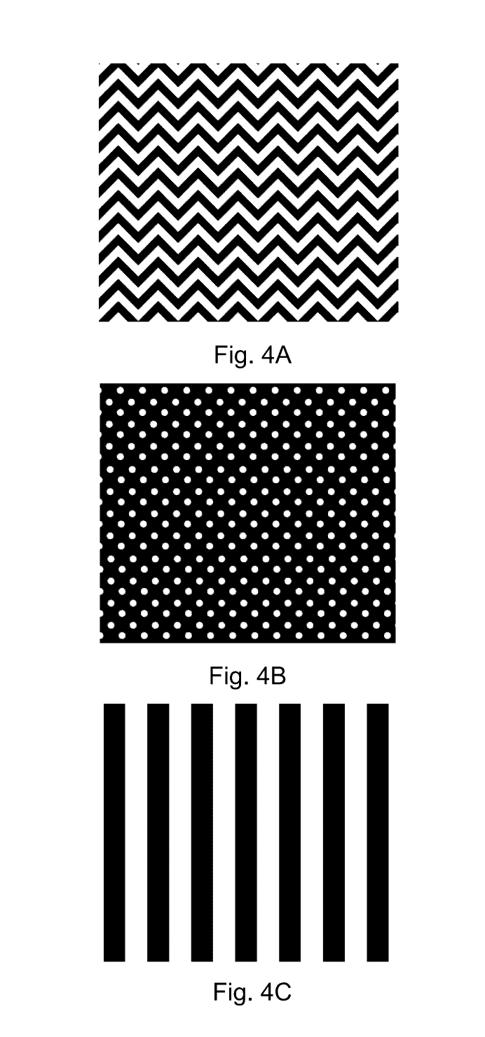

In one embodiment of the present disclosure, the visual design includes at least three colors and has a pattern. For example, the pattern can be a zig zag pattern as shown by FIG. 4A, a dotted pattern as shown by FIG. 4B, or a strip pattern as shown by FIG. 4C. Alternatively, the visual design can also be a color drawing or photo of an object such as food or pet toy that attracts the dog.

In yet another embodiment of the present disclosure, the attractant has a scent that attracts pets, particularly the dogs and cats. Examples of scent may include, but not limited to, grass, pheromones, pee or ammonia. The primary purpose of attractant is to attracts or reminds the pets to use the training pads and so any scent that is capable of achieving such purpose can be used.

Alternatively, the attractant may be in the form of a visual or olfactory signal to trigger a pet to use the designated mat to relieve themselves. The visual signals may be related to patterns that attract animals' attention. The olfactory signal may be in the form of scents to attract the animal first to the pad and then to indicate to the animal that the mat is a good place to relieve themselves. Additionally, the olfactory component may comprise of an odor masking or eliminating emission. The olfactory component may be noticeably present at all times or may not be noticeably present until an animal has soiled the mat and thus triggers the release of an olfactory signal to both mask or eliminate the animal waste smell and alert the owner to the fact that the mat has been used.

In yet another embodiment of the present disclosure, the non-porous material for the bottom layer 10 of the training pad 2 is plastic, specifically polyethylene. An advantage of using polyethylene material (or polyethylene film) is that it is durable and tear-resistant. This prevents the floors, rugs and/or carpets from damage by the training pads when they are being used. Any other non-leaking, durable and tear-resistant material can also be used.

Optionally, the bottom layer of the training pad facing the floor surface and typically the polyethylene film layer further includes an adhesive surface for sticking the training pad temporarily to the floor. In an additional embodiment of the present disclosure instead of placing an adhesive surface on the bottom surface of the mat which is present in other pads, double sided stickers (or Velcro® tape) are capable of being applied directly to a floor surface where one would want the mat to be placed, and/or on the mat itself for optionally securing the mat to a surface.

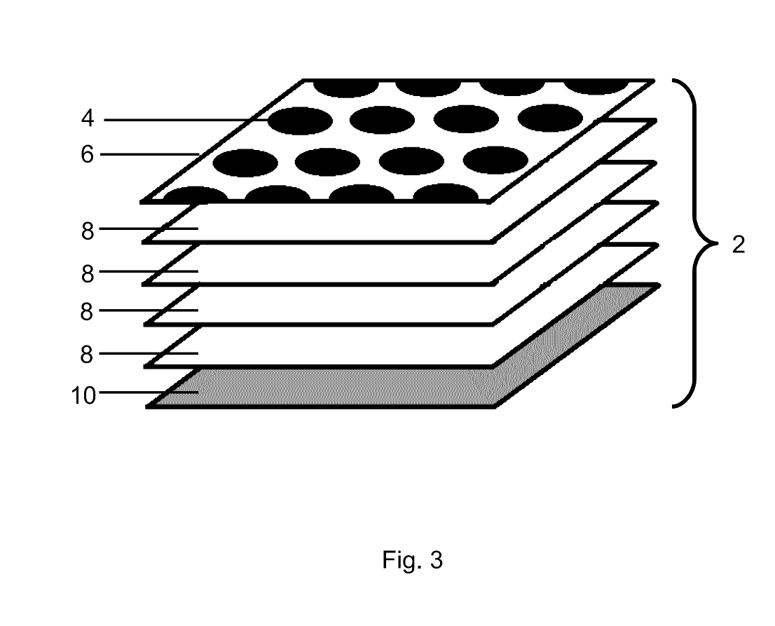

In one preferred embodiment of the present disclosure, as shown by FIG. 3, the disclosed training pads comprise at least five layers of SAP (one top layer 6 and additional four layers 8) which allows the training pads to absorb at least 5 cups of fluid in standard size. SAP also allows quick-drying absorption so that there is no unsightly trail after the pads are being used.

In yet another embodiment of the present disclosure, the training pads further comprise a fragrance (or odor neutralizer) which eliminates urine and/or fecal odor after the training pads are being used. The fragrance can come from the attractant or from an independent chemical agent or natural ingredient.

In yet another embodiment of the present disclosure, the training pad is in a shape of square or rectangle with the side length between 15 to 30 inches. For example, it can be a square in standard size of 23.5″×23.5″ or a rectangle in a size of 20″×25″.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A pet training pad comprising:
a top layer made from superabsorbent polymer and includes a visual design;
a bottom layer made from non-porous material;
at least two layers of absorbent made from superabsorbent polymer are placed between the top layer and the bottom layer; and
an attractant.

2. The pet training pad of claim 1, wherein the visual design includes at least three colors.

3. The pet training pad of claim 1, wherein the visual design is a strip pattern, a dotted pattern or a zig zag pattern.

4. The pet training pad of claim 1, wherein the attractant has a scent of grass, pheromones, pee or ammonia.

5. The pet training pad of claim 1, wherein the non-porous material is polyethylene.

6. The pet training pad of claim 1, wherein the top layer, the bottom layer and the at least two layers of absorbent are squares with side length between 20 to 26 inches.

7. The pet training pad of claim 1, wherein the bottom layer further comprises an adhesive that is capable of temporality sticking one side of bottom layer temporarily to a floor.

8. A pet training pad comprising:
a top layer made from superabsorbent polymer and includes a visual design that has at least three colors;
a bottom layer made from polyethylene film;
at least four layers of absorbent made from superabsorbent polymer are placed between the top layer and the bottom layer;
an attractant; and
an odor neutralizer.

9. The pet training pad of claim 8, wherein the visual design is a strip pattern, a dotted pattern or a zig zag pattern.

10. The pet training pad of claim 8, wherein the attractant has a scent of grass, pheromones, pee or ammonia.

11. The pet training pad of claim 8, wherein the visual design includes at least three different colors.

12. The pet training pad of claim 8, wherein the visual design is a strip pattern, a dotted pattern or a zig zag pattern.

13. The pet training pad of claim 8, wherein the odor neutralizer is selected from chemical agents that neutralize fecal and urine odors.

14. The pet training pad of claim 8, wherein the top layer, the bottom layer and the at least four layers of absorbent are squares with side length between 20 to 26 inches.

15. The pet training pad of claim 8, wherein the bottom layer further comprises an adhesive that is capable of temporality sticking one side of bottom layer temporarily to a floor.

16. A pet training pad consisting of:
a top layer made from superabsorbent polymer and includes a visual design that has at least three colors with a pattern of strip, dot or zig zag;
a bottom layer made from non-porous polyethylene film;
four layers of absorbent made from superabsorbent polymer are placed and stacked between the top layer and the bottom layer;
an attractant with a scent of grass, pheromones, pee or ammonia; and
an odor neutralizer selected from chemical agents that neutralize fecal and urine odors.

17. The pet training pad of claim 16, wherein the top layer, the bottom layer and the four layers of absorbent are squares with side length between 20 to 26 inches.

18. The pet training pad of claim 16, wherein the bottom layer further comprises an adhesive that is capable of temporality sticking one side of bottom layer temporarily to a floor.
